(19) United States
(12) Patent Application Publication
(10) Pub. No.: US 2024/0211928 A1
(43) Pub. Date: Jun. 27, 2024

(54) METHOD TO PING VIRTUAL CARD NUMBERS TO CHECK IF ACTIVE

(71) Applicant: Capital One Services, LLC, McLean, VA (US)

(72) Inventors: Michael Mossoba, Great Falls, VA (US); Tyler Maiman, Melville, NY (US); Joshua Edwards, Philadelphia, PA (US)

(21) Appl. No.: 18/146,073

(22) Filed: Dec. 23, 2022

(51) Int. Cl. G06Q 20/34

(52) U.S. Cl. CPC G06Q 20/351; G06Q 20/354

(57) ABSTRACT

Techniques for exchanging data related to virtual card numbers (VCNs) using an application programming interface (API) of a computing device that manages VCNs are provided. The API enables changes to a VCN made under the direction of a user to be provided to other computing devices. The other computing devices may adjust the provision of services to the user and any transactions related thereto based on the information provided via the API of the computing device that manages the VCNs.

### FIELD OF USE

Aspects of the disclosure relate to application program interfaces (APIs) and the use of virtual card numbers (VCNs).

### BACKGROUND

A service provider may provide a subscription-based service to a user. The user may specify a virtual card number (VCN) to fund the service. The user may make changes to the VCN that may prevent the service provider from being able to charge the VCN. Currently, no mechanism exists for the service provider to become aware of the user's changes to the VCN.

Aspects described herein may address these and other problems, and generally improve the use of VCNs and the exchange of data between a service provider and a financial institution managing the VCNs.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

The present disclosure describes techniques for exchanging data related to virtual card numbers (VCNs) associated with subscription services.

A user may subscribe to a subscription-based service. In exchange, the service may charge the user a monthly subscription fee. The user may provide the service provider with a VCN to fund the fee. The VCN may be a code (e.g., a 16 digit code) tied to a financial account of the user such as, for example, a credit card account of the user. The VCN may be used much like a debit card or a credit card in that it may be used to fund transactions. The user may specify that the VCN is to be used for only certain merchants, may specify a maximum amount that may be charged to the VCN, and/or may place a time limit on when the VCN may be used (e.g., the user may specify that the VCN is no longer valid beyond a certain date). In many instances, the user may make changes to the use of the VCN that prevent the service provider from charging the VCN. For example, the user may time-bound use of the VCN after which time the service provider may no longer be able to charge the VCN to fund the subscription.

Techniques described herein enable data, metadata, and/or other information related to a VCN and/or a subscription service to be exchanged to enable a service provider to become aware of changes to the VCN. A computing device associated with a financial institution that manages the VCN may expose an application programming interface (API) that enables information related to the VCN to be provided to a computing device associated with the service provider. The API of the computing device associated with the financial institution may provide push notifications to the computing device associated with the service provider. The API of the computing device associated with the financial institution may indicate when the VCN is no longer valid such as, for example, when the user disassociates the VCN from the subscription service or when the time-bound use of the VCN has expired. By enabling the API of the computing device associated with the financial institution to provide information related to the VCN to the computing device associated with the service provider, the computing device associated with the service provider may more efficiently manage the user's subscription. For example, the computing device associated with the service provider may avoid repeatedly attempting to charge an invalid VCN.

The techniques described herein further enable the user to manage various different subscription services by managing one or more VCNs via the computing device associated with the financial institution. The user, via an interface provided by the computing device associated with the financial institution, may be able to deactivate and reactivate a subscription service by managing a corresponding VCN associated with the subscription service. For example, the user may be able to deactivate a subscription by deactivating a VCN associated with the subscription service. The user may also be able to reactivate the subscription by reactivating the VCN or activating a new VCN. Any number of subscription services may be managed by the user interacting with a single interface provided by the computing device associated with the financial institution, rather than requiring the user to interact with each different service provider to manage each subscription separately. In turn, the user may manage various different subscription service more efficiently and effectively.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented;

FIG. 2 shows an example computing device;

FIG. 3 shows an example of a process for managing a subscription for a service using one or more VCNs; and

FIG. 4 shows an example of a process for managing a bulk data request related to subscriptions for a service using VCNs.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or instructions stored on non-transitory computer-readable media for managing a subscription for a service using one or more VCNs by facilitating the exchange of information related to the VCNs between computing devices of one or more service providers that provide subscription-based services and a computing device of a financial institution that manages the VCNs under direction of a user.

As an example, a first computing device associated with a financial institution may receive a first request to deactivate a subscription for a service. The first request may be received from a user computing device associated with a user. The subscription for the service may be associated with the user. The first computing device may receive a first virtual card number associated with a financial account from a database based on the first request. The first virtual card number may be associated with the subscription. The first computing device may send a first instruction to deactivate the subscription to a second computing device associated with a provider of the service. The first instruction may include a portion of the first virtual card number. The first computing device, at a later time, may receive a second request from the user computing device to reactivate the subscription. The first computing device may send a second instruction to reactivate the subscription to the second computing device. The second instruction may include a second virtual card number, associated with the financial account, that is different from the first virtual card number. The first computing device may receive a first message indicating that the subscription is reactivated from the second computing device. The first computing device may send a second message indicating that the subscription is reactivated to the user computing device.

The techniques described herein provide improved techniques for managing various different subscription-based services using one or more VCNs. The subscription-based services may be managed—for example, deactivated and/or reactivated—based on managing corresponding VCNs associated with each service. This allows management of the various different subscription-based services through an interface provided by the computing device of the financial institution that manages the VCNs, and avoids the need to interact with each separate service provider.

Aspects described herein improve the functioning of computers by improving the way in which computing devices exchange data or other information related to VCNs in order to manage subscription-based services. Conventional computing devices implementing conventional techniques for managing subscription-based services do not provide any mechanism for a computing device of a financial institution that manages VCNs to provide data related to the management of the VCNs to computing devices of service providers that offer subscription-based services based on the VCNs. As a result, with these conventional systems, when a VCN associated with a particular subscription-based service is no longer valid, the computing device of the service provider is unaware of the status change of the VCN and may repeatedly attempt to charge the VCN to fund a subscription fee. The computing device of the service provider therefore wastes time and energy, and needlessly occupies network and computing resources, attempting to use an invalid VCN. Further, by enabling the exchange of data or other information related to VCNs, a user may interact with the interface of the computing device of the financial institution to manage the various different subscription-based services, obviating the need to separately log on and manage each subscription individually. Conventional computing devices implementing conventional techniques for managing subscription-based services do not allow such flexibility and instead require the user to separately interact with each service provider computing device. As a result, network and computing resources are not used efficiently, and the user must spend more time and effort managing the services.

Having introduced exemplary features, discussion will now turn to a system that may implement the exemplary features and, in particular, to a system that may manage a subscription-based service using one or more VCNs.

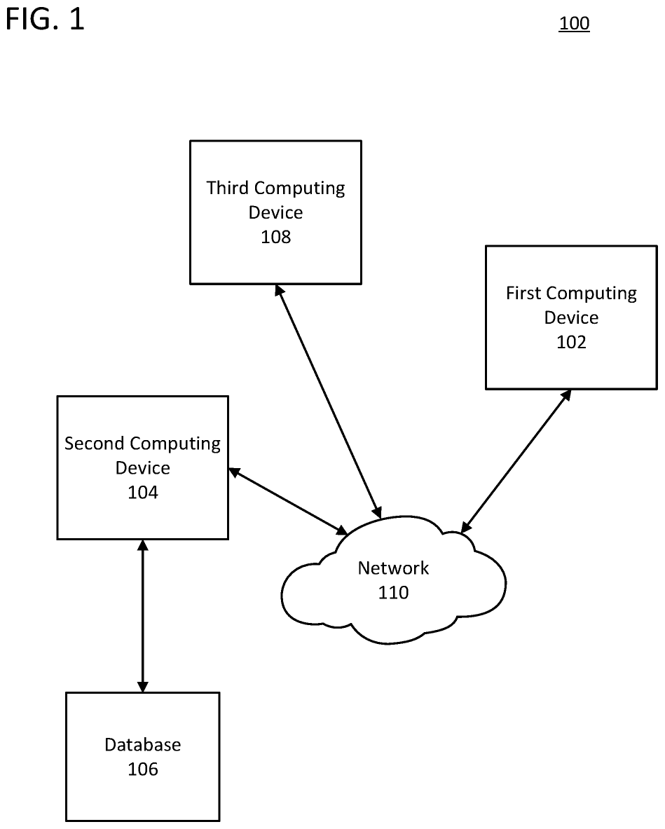

FIG. 1 illustrates a system 100 for managing a subscription for a service according to one or more aspects of the disclosure. The system 100 may include a first computing device 102, a second computing device 104, a database 106, a third computing device 108, and a network 110. The service may be a content streaming service.

The first computing device 102 may be any type of computing device, including a mobile or a portable device. For example, the first computing device 102 may be a smartphone, a laptop, a tablet, a desktop, or an equivalent thereof. The first computing device 102 may be a user computing device such as, for example, a wireless user computing device.

The first computing device 102 may be associated with a user. The user may use the first computing device 102 to interact with an online, web-based, and/or app-based system or user interface provided by the second computing device 104 and/or the third computing device 108 as described herein.

The second computing device 104 may also be any type of computing device. The second computing device 104 may include one or more computers, servers, and/or databases. The second computing device 104 may be and/or may include a server that provides and/or displays content, for example, through storing, processing, and/or delivering content to users. The second computing device 104 may be connected or coupled to the database 106.

The second computing device 104 may be associated with a financial institution. The user associated with the first computing device 102 may have one or more financial accounts with the financial institution associated with the second computing device 104. The user may have a checking account, a savings account, a line of credit, and/or a credit card account provided through the financial institution associated with the second computing device 104. In general, the user associated with the first computing device 102 may have any type of financial account with the financial institution associated with the second computing device 104. The financial institution may be a bank, credit union, credit card company, or any other type of financial institution that may provide one or more financial accounts to an individual.

The second computing device 104 may store in the database 106 information related to various financial accounts maintained by the financial institution associated with the second computing device 104. For example, the second computing device 104 and/or the database 106 may store data or other information related to one or more virtual card numbers (VCNs) associated with one or more financial accounts maintained by the financial institution associated with the second computing device 104. The user may manage the VCNs using the first computing device 102 via interaction with the second computing device 104. For example, the user may direct the second computing device 104 (e.g., via the first computing device 102) to associate one or more VCNs to one or more merchants, services, and/or subscriptions as described herein.

The third computing device 108 may also be any type of computing device. The third computing device 108 may include one or more computers, servers, and/or databases. The third computing device 108 may be and/or may include a server that provides and/or displays content, for example, through storing, processing, and/or delivering content to users.

The third computing device 108 may be associated with an entity (e.g., a company, merchant, or store) that sells or provides various products and/or services. For example, the third computing device 108 may be associated with a merchant that provides a subscription service. The service may be a subscription-based content streaming service.

The network 110 may be any type of communications and/or computer network. The network 110 may include any type of communication mediums and/or may be based on any type of communication standards or protocols. The network 110 communicatively couples the first computing device 102, the second computing device 104, and the third computing device 108 to one another, to enable data and/or other information to be shared between the first computing device 102, the second computing device 104, the third computing device 108, and the database 106.

As mentioned, the third computing device 108 may be associated with a merchant or other entity that provides a content streaming service. The content streaming service may be provided via a subscription. For example, the merchant associated with the third computing device 108 may provide the content streaming service to the user associated with the first computing device 102 (e.g., as a subscriber to the service) based on a monthly payment provided by the subscriber. As a result of subscribing to the content streaming service, the user associated with the first computing device 102 may receive and/or access content (e.g., via the first computing device 102) provided by the third computing device 108.

The user associated with the first computing device 102 may manage the subscription to the content streaming service via interaction with the second computing device 104. The user associated with the first computing device 102 may have and/or may manage one or more VCNs associated with one or more financial accounts maintained by the financial institution associated with the second computing device 104. The user, via the first computing device 102, may direct the second computing device 104 to submit payment for the content streaming service using a VCN. For example, at a time when a charge for the content streaming service is due, the third computing device 108 may issue a message to the second computing device 104 requesting payment. In response, the second computing device 104 may provide the third computing device 108 with a VCN to charge. The VCN may be linked or associated with a financial account of the user (e.g., a credit card account) such that the financial account of the user provides the funds for a monthly subscription fee when the VCN is charged.

The second computing device 104 may provide an interface (e.g., online, web-based, and/or app-based) that the user may access via the first computing device 102 to create a VCN and/or to specify which VCN to use to pay for the content streaming service. The interface may allow the user, via the first computing device 102, to specify which VCN to associate with a particular merchant, such as the merchant associated with the third computing device 108.

Techniques described herein allow the user to manage the subscription service using the interface provided by the second computing device 104. For example, the user may interact with the interface provided by the second computing device 104 to deactivate and reactivate the subscription service. As a result, the user need not interact with the third computing device 108 to deactivate and reactivate the subscription service provided by the merchant associated with the third computing device 108. This enables the user to manage various subscription services via one interface—the interface provided by the second computing device 104. In turn, the user is not required to separately logon and interact with different interfaces for each subscription service in order to manage the subscriptions (e.g., deactivate and reactivate).

As an example, the user associated with the first computing device 102 may decide to deactivate the user's subscription to the content streaming service provided by the third computing device 108. To do so, the user may use the first computing device 102 to log on to a user interface provided by the second computing device 104. By logging on to the user interface provided by the second computing device 104, the user may operate within a session for managing one or more financial accounts of the user including, for example, managing one or more VCNs associated with the user and or the user's financial accounts. Logging on may entail the user providing, via the first computing device 102, one or more of a user identification (ID) and a password. Other authentication schemes and protocols, such as a multiple factor authentication scheme, may be implemented or required to grant the user a secure and/or authorized session for interacting with the second computing device 104.

Once logged in to the user interface, the user may specify (e.g., via a request issued by the first computing device 102) that the user's subscription to the content streaming service provided by the third computing device 108 is to be deactivated. The user may specify a request to deactivate a subscription by deactivating a particular VCN previously linked or associated with the subscription and/or by disassociating a particular VCN previously linked or associated with the subscription.

In response to receiving a request to deactivate the subscription from the first computing device 102, the second computing device 104 may send a message or instruction to the third computing device 108. The message may contain information to identify the subscription of the user such as, for example, an email address of the user, a name of the user, a subscription ID, and/or the VCN of the user used to fund the subscription, or any combination thereof, including a subset of any of the aforementioned information (e.g., the last four (4) digits of the VCN). As a particular example, the message may include an email address of the user, the last four (4) digits of the VCN used to fund the subscription, and an indication that the subscription is to be canceled and/or deactivated.

In response to receiving a request to deactivate the subscription from the second computing device 104, the third computing device 108 may send a message to the second computing device 104 acknowledging receipt of the request. The third computing device 108 may deactivate the subscription service for the user such that the user may no longer access content via the first computing device 102 that may be provided by the third computing device 108. The third computing device 108 may also discontinue periodic (e.g., monthly) billing or charge requests to the second computing device 104.

To facilitate interaction and/or communication, the second computing device 104 may include an application programming interface (API) that enables the second computing device 104 to send communications to the third computing device 108 and/or to receive communications from the third computing device 108. Similarly, the third computing device 108 may include an API that enables the third computing device 108 to send communications to the second computing device 104 and/or to receive communications from the second computing device 104. The APIs may ensure that information related to the user's subscription may be shared including information identifying the subscription, the user, and/or the VCN used to fund the subscription.

As another example, at a later time after deactivating the subscription, the user associated with the first computing device 102 may decide to reactivate the user's subscription to the content streaming service provided by the third computing device 108. To do so, the user may use the first computing device 102 to log on to the user interface provided by the second computing device 104. Once logged in to the user interface, the user may specify (e.g., via a request issued by the first computing device 102) that the user's subscription to the content streaming service provided by the third computing device 108 is to be reactivated. The user may specify a request to reactivate a subscription by reactivating a particular VCN previously linked or associated with the subscription and/or by re-associating a particular VCN previously linked or associated with the subscription. Alternatively, the user may specify or indicate a new VCN be used.

In response to receiving a request to reactivate the subscription from the first computing device 102, the second computing device 104 may send a message or instruction to the third computing device 108. The message may contain information to identify the subscription of the user such as, for example, an email address of the user, a name of the user, a subscription ID, and/or the VCN of the user (e.g., a new or prior VCN) used to fund the subscription, or any combination thereof, including a subset of any of the aforementioned information. As a particular example, the message may include an email address of the user, the last four (4) digits of the VCN used to fund the subscription, and an indication that the subscription is to be restarted or reactivated.

In response to receiving a request to reactivate the subscription from the second computing device 104, the third computing device 108 may send a message to the second computing device 104 acknowledging receipt of the request. The third computing device 108 may reactivate the subscription service for the user such that the user may begin to access content via the first computing device 102 that may be provided by the third computing device 108. The third computing device 108 may also re-initiate periodic (e.g., monthly) billing or charge requests to the second computing device 104 and/or may immediately charge the VCN provided.

As a further example, the third computing device 108 may initiate communications to the second computing device 104 to determine a status of a subscription service provided to the user. The third computing device 108 may be provided with a VCN that is to be charged periodically. At a time when the VCN is to be charged, the third computing device 108 may determine that the transaction may not be completed because, for example, the VCN is no longer valid. In response, the third computing device 108 may send a message to the second computing device 104 requesting a status of the VCN and/or a user's intended status of the subscription.

The message may include information identifying the user and/or the particular subscription service such as, for example, an email address or the user and/or an account ID of the user. The message may include the VCN or a portion thereof. The second computing device 104 may receive and process the message from the third computing device 108. For example, based on the information provided in the message from the third computing device 108, the second computing device 104 may determine that the user requested the subscription to be deactivated (e.g., by disassociating the VCN from the subscription service). The second computing device 104 may send a responsive message to the third computing device 108 indicating that the VCN is no longer valid and/or useable for the subscription. The message may effectively inform the third computing device 108 that the user wishes to cancel the subscription. In this manner, the third computing device 108 may more quickly determine a status of the user's intent with the subscription, thereby avoiding repeated attempts to charge the VCN without resolution of the attempted transaction.

Additionally, the second computing device 104 and the third computing device 108 may operate to support batch (e.g., bulk) requests regarding the status of VCNs for multiple different users (e.g., subscribers) that may have a subscription to a service provided by a merchant associated with the third computing device 108. To facilitate batch servicing, the second computing device 104 may generate a token. The token may comprise encrypted data. The data may be any data including random data. The data may be encrypted using any technology, standard, or protocol.

The token may be provided by the second computing device 104 to the third computing device 108. The token may be associated with multiple users who have financial accounts with the financial institution associated with the second computing device 104 and who also have (or had) a subscription to a service provided by the merchant associated with the third computing device 108. The second computing device 104 may instruct third computing device 108 to provide the token in conjunction with any message requesting the status of multiple users' VCNs and/or subscription statuses. For example, the token may be required to be provided when the third computing device 108 requests status on the VCNs or subscription status for a relatively large number of users (e.g., more than one (1) user, more than 100 users, etc.). Alternatively, a modified token may be required, with the modified token based on the initial token. For example, the modified token may be a different encryption of the underlying data of the initial token.

The token or modified token may serve to verify the batch request from the third computing device 108 as a legitimate request. In this manner, the merchant associated with the third computing device 108 may proactively determine a subscription status and/or VCN status for a service provided to one or more subscribers. This allows the merchant associated with the third computing device 108 to more effectively and efficiently determine when a subscriber has determined to cancel a subscription rather than repeatedly attempting to charge the user's VCN multiple times in an attempt to seek payment for the subscription fee.

Information related to the user's subscription and any VCNs related to the subscription may be stored in the database 106. The second computing device 104 may access the information stored in the database 106 in response to any request or instruction received from the first computing device 102 and/or in response to any request or message received from the third computing device 108. The database 106 may store and/or correlate records or other information for a user of the first computing device 102.

For example, the database 106 may store information associating a financial account of the user (e.g., a checking account of the user or a credit card account of the user) to a first VCN. Further, the database 106 may store information associating the first VCN to a subscription service provided by the merchant associated with the third computing device 108. When a charge request for the subscription service is issued from the third computing device 108 to the second computing device 104, the second computing device 104 may use information provided in the charge request (e.g., an ID of the user, a portion of the VCN, etc.) to identify the financial account to be charged (e.g., to fund the subscription fee).

The user, via the first computing device 102, may log on to the user interface provided by the second computing device 104. The user, via the first computing device 102 and the user interface, may indicate that a particular subscription service should be deactivated and/or that a particular VCN should be disassociated with a particular subscription service. The second computing device 104 may use information identifying the user (e.g., based on the user's logon credentials) and/or information from the user's request to retrieve the VCN and/or information identifying the subscription service that may be stored in the database 106. In this manner, the second computing device 104 may provide information to the third computing device 108 to fulfill the user's request to deactivate the particular subscription.

Similarly, the third computing device 108 may request information from the second computing device 104 regarding a particular subscriber, a particular VCN, and/or a particular subscription. The request from the third computing device 108 may include some identifying information for the particular subscriber, particular VCN, and/or particular subscription. The second computing device 104 may use information from the request from the third computing device 108 to retrieve the VCN and/or information identifying the subscription service that may be stored in the database 106. In this manner, the second computing device 104 may provide information to the third computing device 108 to fulfill the request to determine a status of a particular subscription for a particular user (e.g., whether the user recently canceled the subscription).

As described above, a user may specify (e.g., manually through the interface provided by the second computing device 104) that a particular VCN should be deactivated and/or disassociated from a particular subscription service. The user may also time-bound a VCN such that after a certain time period (e.g., after a certain date), the VCN is no longer valid and/or useable. Outside of a time period where the VCN is valid, the VCN cannot be charged successfully to fund any purchase (e.g., a monthly subscription fee). Under either scenario, techniques described herein allow the second computing device 104 to provide push notifications to the third computing device 108 regarding the status of a VCN associated with a subscription service. The techniques described herein also allow the third computing device 108 to request pull notifications regarding the status of a VCN associated with a subscription service. APIs—for example, VCN status APIs—of the second computing device 104 and the third computing device 108 may provide the ability to provide such push and pull notifications.

As mentioned, the techniques described herein enable the user to manage subscriptions for various different services by interacting with the second computing device 104 (e.g., via the first computing device 102), without having to separately interact with each different service provider. As a result, the user may manage the subscriptions more quickly and efficiently without the need to separately log on to interfaces for each service provider. The user may instead interact with the second computing device 104 to create VCNs, and to associate (e.g., link or activate) and disassociate (e.g., unlink or deactivate) the VCNs to particular services, to corresponding activate, reactivate, and deactivate the subscriptions.

Discussion will now turn to an example device that may be used to implement one or more aspects described herein.

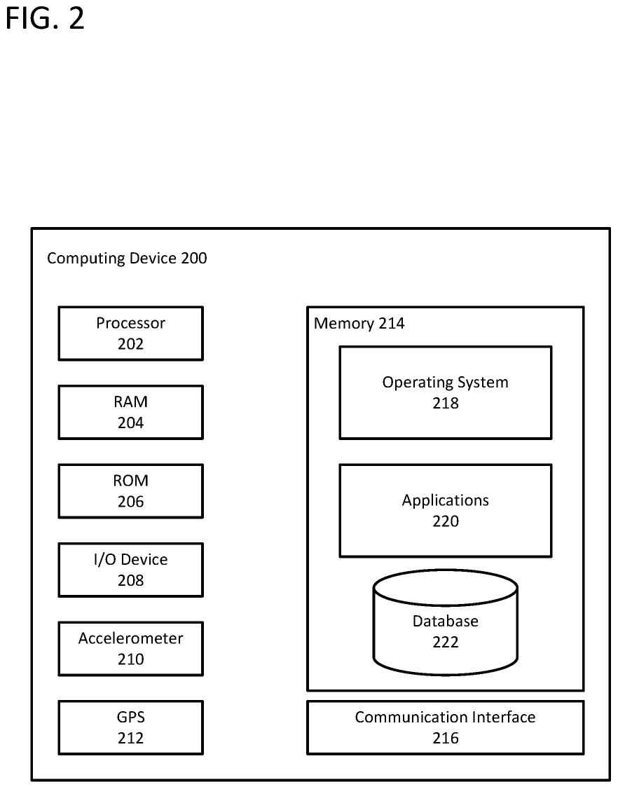

Any of the devices, components, and/or systems described herein may be implemented, in whole or in part, using one or more computing devices described with respect to FIG. 2. Turning now to FIG. 2, a computing device 200 that may be used with one or more of the computational systems is described. The computing device 200 may comprise one or more processors 202 for controlling overall operation of the computing device 200 and its associated components, including random access memory (RAM) 204, read-only memory (ROM) 206, input/output device 208, accelerometer 210, global-position system (GPS) antenna 212, memory 214, and/or communication interface 216. A bus (not shown in FIG. 2 for simplicity) may interconnect processor(s) 202, RAM 204, ROM 206, I/O device 208, accelerometer 210, global-position system receiver/antenna 212, memory 214, and/or communication interface 216. Computing device 200 may represent, be incorporated in, and/or comprise various devices such as a desktop computer, a computer server, a gateway, a mobile device, such as a laptop computer, a tablet computer, a smartphone, any other types of mobile computing devices, and the like, and/or any other type of data processing device.

Input/output (I/O) device 208 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 214 to provide instructions to processor 202 allowing computing device 200 to perform various actions. For example, memory 214 may store software used by the computing device 200, such as an operating system 218, application programs 220, and/or an associated internal database 222. The various hardware memory units in memory 214 may comprise volatile and nonvolatile, removable and non-removable media implemented in any method or technology for storage of information such as computer-readable instructions, data structures, program modules, or other data. Memory 214 may comprise one or more physical persistent memory devices and/or one or more non-persistent memory devices. Memory 214 may comprise RAM, ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 202.

Accelerometer 210 may be a sensor configured to measure accelerating forces of computing device 200. Accelerometer 210 may be an electromechanical device. Accelerometer 210 may be used to measure the tilting motion and/or orientation computing device 200, movement of computing device 200, and/or vibrations of computing device 200. The acceleration forces may be transmitted to the processor 202 to process the acceleration forces and determine the state of computing device 200.

GPS receiver/antenna 212 may be configured to receive one or more signals from one or more global positioning satellites to determine a geographic location of computing device 200. The geographic location provided by GPS receiver/antenna 212 may be used for navigation, tracking, and positioning applications. In this regard, the geographic location may also include places and routes frequented by the user.

Communication interface 216 may comprise one or more transceivers, digital signal processors, and/or additional circuitry and software, protocol stack, and/or network stack for communicating via any network, wired or wireless, using any protocol as described herein.

Processor 202 may comprise a single central processing unit (CPU), which may be a single-core or multi-core processor, or may comprise multiple CPUs. Processor(s) 202 and associated components may allow the computing device 200 to execute a series of computer-readable instructions (e.g., instructions stored in RAM 204, ROM 206, memory 214, and/or in other memory of computing device 200) to perform some or all of the processes described herein. Although not shown in FIG. 2, various elements within memory 214 or other components in computing device 200, may comprise one or more caches, for example, CPU caches used by the processor 202, page caches used by the operating system 218, disk caches of a hard drive, and/or database caches used to cache content from database 222. A CPU cache may be used by one or more processors 202 to reduce memory latency and access time. A processor 202 may retrieve data from or write data to the CPU cache rather than reading/writing to memory 214, which may improve the speed of these operations. In some examples, a database cache may be created in which certain data from a database 222 is cached in a separate smaller database in a memory separate from the database 222, such as in RAM 204 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single computing device and/or multiple computing devices in communication without departing from the disclosure.

Discussion will now turn to an example manner in which a user may manage a subscription for a service.

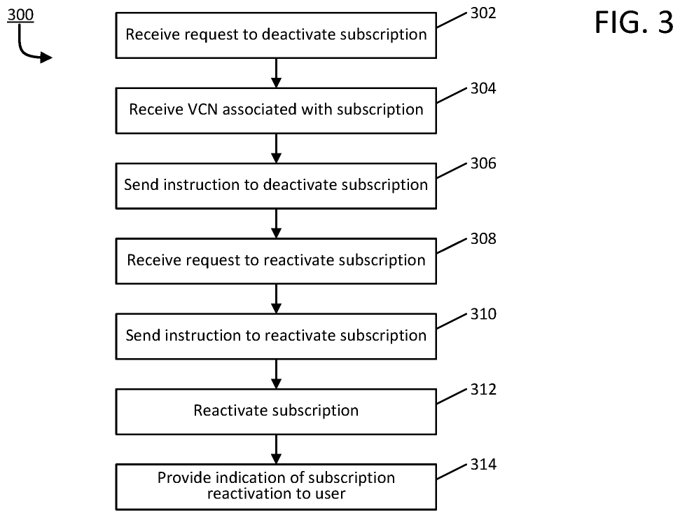

FIG. 3 shows a flow chart of a process 300 for managing a subscription for a service using one or more VCNs. Some or all of the steps of process 300 may be performed using one or more computing devices (e.g., an application executing on a computing device) as described herein, including, for example, a client device, a server, or a memory and a processor configured to perform the methods described herein. For example, any portion of the process may be performed using the first computing device 102 of FIG. 1, the second computing device 104 of FIG. 1, the third computing device 108 of FIG. 1, or the computing device 200 of FIG. 2.

The process 300 is described in relation to a user (e.g., the user associated with the first computing device 102 of FIG. 1) who currently or presently has a subscription for a service. The service may be provided by a computing device associated with a merchant or other entity (e.g., the third computing device 108 of FIG. 1). The service may be a subscription-based content streaming service that provides the user (e.g., via the first computing device 102) with access to content. The user may manage the subscription via a computing device associated with a financial institution (e.g., the second computing device 104) as described herein. The financial institution may have associated a VCN with the subscription service, under direction of the user. The computing device associated with the provider of the service may be initially provided with information regarding the VCN when the user establishes the subscription.

In step 302, a computing device associated with a financial institution (e.g., the second computing device 104 of FIG. 1) may receive a first request to deactivate the subscription for the service. The subscription may be associated with the user and the first request may be issued by a computing device associated with the user (e.g., the first computing device 102 of FIG. 1). The first request may include a first indication to deactivate and/or to disable a particular VCN (e.g., a first VCN) that may be associated with the subscription.

In step 304, the computing device associated with the financial institution may receive/retrieve from a database (e.g., the database 106 of FIG. 1) a first VCN associated with the subscription. The first request may contain information to enable the computing device associated with the financial institution and/or the database to determine which user issued the first request, which subscription service is associated with the first request, and/or which VCN (e.g., the first VCN) is associated with the subscription service. As such, the computing device associated with the financial institution may access the database based on information provided in the first request.

In step 306, the computing device associated with the financial institution may send a first instruction to deactivate the subscription. The first instruction may be sent to a computing device associated with a provider of the subscription service (e.g., the third computing device 108 of FIG. 1). The first instruction may include information identifying the subscription, the user, and/or the first VCN. For example, the first instruction may include a portion of the first VCN. The first instruction may include an email address of a user associated with the subscription service. In response to receiving the first instruction, the computing device associated with the provider of the subscription service may deactivate the subscription service. The computing device associated with the provider of the subscription service may issue a message to the computing device associated with the financial institution that the subscription is deactivated.

Additionally and/or alternatively, the computing device associated with a provider of the subscription service may request information (e.g., a status update) on a particular user and/or a particular subscription. At any time, the computing device associated with a provider of the subscription service may ping the computing device associated with the financial institution for any information regarding a particular user and/or a particular subscription. To do so, the computing device associated with a provider of the subscription service may provide a message to the computing device associated with the financial institution that identifies a particular user and/or a particular subscription account. In response, the computing device associated with the financial institution may provide a responsive message to the computing device associated with a provider of the subscription service that indicates whether the subscription is activated or deactivated and may indicate any recent user changes, instructions, or requests associated with the particular account. As an example, the computing device associated with the financial institution may indicate that the user recently issued a request to deactivate a subscription. The computing device associated with a provider of the subscription service may then deactivate the subscription based on such notification from the computing device associated with the financial institution. In this manner, the computing device associated with a provider of the subscription service may pull information regarding a user or account from the computing device associated with the financial institution.

In step 306, the user that initiated the request in step 302 may receive a message indicating that the subscription has been deactivated and/or canceled. The message may be issued by the computing device associated with a provider of the subscription service and/or the computing device associated with the financial institution.

In step 308, the computing device associated with a financial institution may receive a second request to reactivate the subscription for the service. The second request may be issued by the computing device associated with the user. The second request may include a second indication to activate and/or to associate a VCN (e.g., a second VCN) to the subscription service.

In step 310, the computing device associated with the financial institution may send a second instruction to reactivate the subscription. The second instruction may be sent to the computing device associated with the provider of the subscription service The second instruction may include information identifying the subscription, the user, and/or a VCN. For example, the second instruction may include a second VCN that is different from the first VCN. The second instruction may include an email address of the user associated with the subscription service.

In step 312, the computing device associated with the provider of the subscription service may reactivate the subscription service. The subscription service may be reactivated based on the computing device associated with the provider of the subscription service receiving the second instruction. The computing device associated with the provider of the subscription service may send a first message to the computing device associated with a financial institution indicating that the subscription is reactivated. The first message may include an indication that a fee has been charged to the second VCN to reactivate the subscription service. Alternatively and/or in addition thereto, the computing device associated with the provider of the subscription service may send a message to the computing device associated with the user indicating that the subscription is reactivated. The message sent to the computing device associated with the user may also include an indication that a fee has been charged to the second VCN to reactivate the subscription service.

In step 314, the computing device associated with a financial institution may inform the computing device associated with the user that the subscription is reactivated. For example, the computing device associated with a financial institution may send a second message to the computing device associated with the user indicating reactivation of the subscription. The second message may include an indication that a fee has been charged to the second VCN to reactivate the subscription service.

The process 300 is not limited to a subscription service (e.g., a subscription-based content streaming service). The process 300 may be used to manage the purchase of any product or service from a merchant using one or more VCNs. Further, the steps of process 300 may be implemented in any order and are not limited to being implemented in the order shown or as discussed herein.

The VCNs, and/or the financial accounts associated with the VCNs, used to initially fund and to reactivate the subscription may be owned and/or controlled by a single user, may be shared between various users (e.g., among members of a same household), or may be owned and/or controlled by a second user. For example, the first and second VCNs may be linked or associated with a first financial account of a second user that authorizes another user to use the VCNs to manage the subscription service.

The process 300 enables management of the subscription service using multiple management requests. For example, during the same logon session between the computing device associated with the user and the computing device associated with the financial institution, the user may issue a first request to deactivate the subscription at some first future date and the user may also issue a second request to reactivate the subscription at some second future date (e.g., that is after the first future date). The computing device associated with the financial institution may receive and process these requests and may automatically issue instructions responsive to the requests at an appropriate time (e.g., on the first and second future dates).

As an example, in step 302, the first request to deactivate the subscription for the service may indicate a first future date on which the user requests the subscription to end. As such, the computing device associated with financial instruction may store information related to the first request (e.g., in the database 106 of FIG. 1). On or about on the first future date, the computing device associated with financial instruction, in step 306, may automatically send the first instruction to the computing device associated with the service provider.

Similarly, in step 308, the second request to reactivate the subscription for the service may indicate a second future date on which the user requests the subscription to restart. As such, the computing device associated with financial instruction may store information related to the second request (e.g., in the database 106 of FIG. 1). On or about on the second future date, the computing device associated with financial instruction, in step 310, may automatically send the second instruction to the computing device associated with the service provider.

In this manner, a user may conveniently manage subscription services using VCNs through interaction with the user's financial institution, rather than having to interact with each service provider separately. Further, the user may specify actions to be performed in relation to one or more subscription services in advance, with the computing device associated with the user's financial instruction implementing the actions automatically on one or more specified future dates. This enables the user to specify subscription cancelation and restart dates within the same logon session with the computing device associated with the user's financial instruction. As a result, a message indicating that the service is deactivated (e.g., responsive to the first request to step 302) may be issued by the computing device associated with the service provider and may be received by the computing device associated with the financial institution after the second request to restart the service (in step 308) is issued.

Communications between the computing device associated with the financial institution and the computing device associated with the service provider may use tokens. Tokens may be used to authenticate communications from the computing device associated with the service provider as legitimate. The computing device associated with the financial institution may generate a secure token and may share the secure token with the computing device associated with the service provider. In communications from the computing device associated with the service provider back to the computing device associated with the financial institution, the computing device associated with the service provider may be expected to include the secure token (or some expected variation thereof). For example, in step 312, the first message sent by the computing device associated with the provider of the subscription service may include the secure token as well as an indication that the subscription is reactivated. In general, any entity may generate a token and may expect a complementary entity to provide the token or a known variation thereof when communicating in order to authenticate an initiator of any communications/data requests.

Discussion will now turn to an example manner for managing bulk data requests involving subscription services.

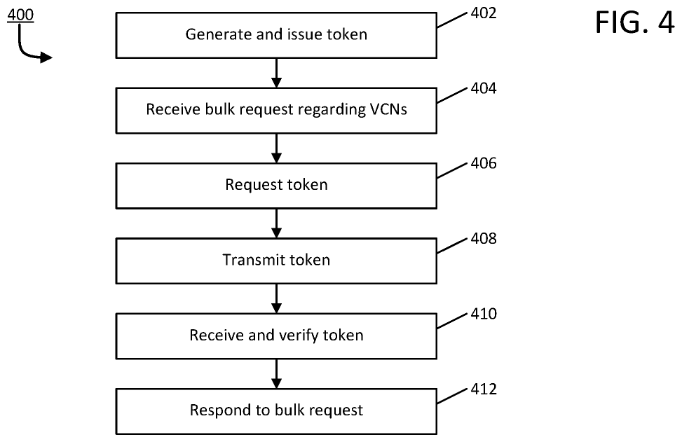

FIG. 4 shows a flow chart of a process 400 for managing a bulk data request related to subscriptions for a service using VCNs. Some or all of the steps of process 400 may be performed using one or more computing devices (e.g., an application executing on a computing device) as described herein, including, for example, a client device, a server, or a memory and a processor configured to perform the methods described herein. For example, any portion of the process may be performed using the first computing device 102 of FIG. 1, the second computing device 104 of FIG. 1, the third computing device 108 of FIG. 1, or the computing device 200 of FIG. 2.

The process 400 is described in relation to a computing device of a financial institution (e.g., the computing device 104 of FIG. 1) that operates to manage subscriptions to a service provided by a computing device associated with the service provider (e.g., the computing device 108 of FIG. 1). The subscriptions may be all provided to subscribers who each manage the subscriptions using one or more VCNs provided by the computing device associated with the financial institution.

In step 402, the computing device associated with the financial institution may generate and issue a token. The token may be considered to be a secure token or an authentication token. The token may be generated according to any standard or protocol. The computing device associated with the financial institution may send the token to the computing device associated with the service provider.

In step 404, computing device associated with the service provider may issue a bulk request. The bulk request may request information regarding multiple subscribers that use one or more VCNs to manage their subscriptions with the service provider. The bulk request may request a status of each subscription or VCN associated with a subscription. Such a status request may be considered a ping. For example, the bulk request may identify a VCN associated with each subscription and may request confirmation that the VCN is still valid. The computing device associated with the service provider may send the bulk request to the computing device associated with the financial institution.

In step 406, in response to receiving the bulk request, the computing device associated with the financial institution may request the token. The computing device associated with the financial institution may request the token to verify a source or identity of the entity making the bulk request. The computing device associated with the financial institution may issue the request for the token to the computing device associated with the service provider.

In step 408, the computing device associated with the service provider may provide the token to the computing device associated with the financial institution. The computing device associated with the service provider may associate the token with the bulk request issued in step 404. The same token may be provided that was generated in step 402. Alternatively, an expected variation of the token may be provided. For example, the token generated in step 402 may be formed by encrypting random data in a first manner. A variation of the token may be generated by encrypting the underlying random data in a second, different manner. The computing device associated with the financial institution may expect to receive the variation of the token in response to the request of step 406.

In step 410, the computing device associated with the financial institution may receive and may verify the token (or the variation of the token). If the token is verified, then the computing device associated with the financial institution may proceed with responding to the bulk request issued by the computing device associated with the service provider. If the token is not verified, then the computing device associated with the financial institution may not proceed with responding to the bulk request issued by the computing device associated with the service provider.

In step 412, in response to verifying the token received in step 410, the computing device associated with the financial institution may issue one or more responsive messages. The messages may be generated and issued in response to the bulk request from the computing device associated with the service provider. The messages may identify one or more subscribers, may indicate one or more VCNs associated with each subscriber, and may indicate whether one or more (or any) of the VCNs for a particular subscriber are active and/or otherwise authorized to be used to fund the subscription service.

For example, the response to the bulk request may provide information regarding two subscribers. For the first subscriber, the response may indicate that a first VCN of the first subscriber is no longer valid. Consequently, the subscription for the first subscriber is to be terminated or deactivated. The computing device associated with the service provider may proceed to terminate or deactivate the subscription service for the first subscriber based on the response provided. For the second subscriber, the response may indicate that a second VCN of the second subscriber is no longer valid, and that a third VCN of the second subscriber is valid and is associated with the subscription service. Consequently, the subscription for the second subscriber is to remain active. The computing device associated with the service provider may proceed to store the new third VCN in association with the subscription service for the second subscriber based on the response provided.

In this manner, the process 400 allows the computing device associated with the service provider to determine the subscription status (e.g., VCN status) for a relatively large number of subscribers at one time, without having to message the computing device associated with the financial institution multiple times. By enabling bulk requests and responses thereto, the techniques described herein obviate the need for exchanging a relatively large number of messages between the computing device associated with the financial institution and the computing device associated with the service provider. In turn, subscription services for a relatively large number of individuals may be managed more quickly and efficiently. Further, the process 400 allows the subscriptions to be managed without having to separately authenticate each request related to each individual subscription.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method comprising:
receiving, at a first computing device and from a user computing device, a first request to deactivate a subscription for a service, wherein the subscription is associated with a user;
receiving, by the first computing device and from a database, and based on the first request, a first virtual card number of an account, wherein the first virtual card number is associated with the subscription;
sending, from the first computing device and to a second computing device, associated with a provider of the service, a first instruction to deactivate the subscription, wherein the first instruction comprises a portion of the first virtual card number;
receiving, at the first computing device and from the user computing device, a second request to reactivate the subscription;
sending, from the first computing device and to the second computing device, a second instruction to reactivate the subscription, wherein the second instruction comprises a second virtual card number, different from the first virtual card number, of the account;
receiving, at the first computing device and from the second computing device, a first message indicating that the subscription is reactivated; and
sending, from the first computing device and to the user computing device, a second message indicating that the subscription is reactivated.

2. The method of claim 1, wherein the first request comprises a first indication to deactivate the first virtual card number, and wherein the second request comprises a second indication to activate the second virtual card number.

3. The method of claim 1, wherein the account is owned by a second user.

4. The method of claim 1, wherein the first message comprises a notification that a fee has been charged to the second virtual card number.

5. The method of claim 1, wherein the second instruction comprises an email address associated with the user.

6. The method of claim 1, wherein the first request indicates a future date on which the user requests the subscription to end, and wherein the first instruction is sent automatically on the future date.

7. The method of claim 1, wherein the second request indicates a future date on which the user requests the subscription to begin, and wherein the second instruction is sent automatically on the future date.

8. The method of claim 1, wherein the first request and the second request are received during a same login session between the user computing device and the first computing device.

9. The method of claim 1, wherein the first message comprises a token, issued by the first computing device, authenticating the second computing device.

10. The method of claim 1, further comprising receiving, at the first computing device and from the second computing device, a third message, responsive to the first instruction, indicating that the subscription is deactivated.

11. The method of claim 10, wherein the third message is received after receiving the second request.

12. The method of claim 1, wherein the service is a content streaming service.

13. An apparatus comprising:
one or more processors; and
memory storing instructions that, when executed by the one or more processors, cause the apparatus to:
receive, from a user computing device, a first request to deactivate a subscription for a service, wherein the subscription is associated with a user;
receive, from a database, and based on the first request, a first virtual card number of an account, wherein the first virtual card number is associated with the subscription;
send, to a first computing device, associated with a provider of the service, a first instruction to deactivate the subscription, wherein the first instruction comprises a portion of the first virtual card number;
receive, from the user computing device, a second request to reactivate the subscription;
send, to the first computing device, a second instruction to reactivate the subscription, wherein the second instruction comprises a second virtual card number of the account, wherein the second virtual card number is different from the first virtual card number;
receive, from the first computing device, a first message indicating that the subscription is reactivated; and
send, to the user computing device, a second message indicating that the subscription is reactivated.

14. The apparatus of claim 13, wherein the first request comprises a first indication to deactivate the first virtual card number, wherein the second request comprises a second indication to activate the second virtual card number, and wherein the service is a content streaming service.

15. The apparatus of claim 13, wherein the account is owned by a second user.

16. The apparatus of claim 13, wherein the first request indicates a future date on which the user requests the subscription to end, and wherein the first instruction is sent automatically on the future date.

17. The apparatus of claim 13, wherein the second request indicates a future date on which the user requests the subscription to begin, and wherein the second instruction is sent automatically on the future date.

18. The apparatus of claim 13, wherein the first request and the second request are received during a same login session with the user computing device.

19. The apparatus of claim 13, further comprising receiving from the first computing device, a third message, responsive to the first instruction, indicating that the subscription is deactivated, wherein the third message is received after receiving the second request.

20. One or more non-transitory media storing instructions that, when executed by one or more processors, cause the one or more processors to perform steps comprising:
receive, from a user computing device, a first request to deactivate a subscription for a content streaming service, wherein the subscription is associated with a user;
receive, from a database, and based on the first request, a first virtual card number of an account, wherein the first virtual card number is associated with the subscription;
send, to a first computing device, associated with a provider of the content streaming service, a first instruction to deactivate the subscription, wherein the first instruction comprises a portion of the first virtual card number;
receive, from the user computing device, a second request to reactivate the subscription;
send, to the first computing device, a second instruction to reactivate the subscription, wherein the second instruction comprises a second virtual card number of the account;
receive, from the first computing device, a first message indicating that the subscription is reactivated; and
send, to the user computing device, a second message indicating that the subscription is reactivated.
